(19) United States
(12) Patent Application Publication
(10) Pub. No.: US 2026/0078296 A1
(43) Pub. Date: Mar. 19, 2026

(54) SUSTAINED-RELEASE SCALE INHIBITORS

(71) Applicant: Materials Engineering and Technical Support Services Corporation, Westerville, OH (US)

(72) Inventors: Kenneth J. Heater, Delaware, OH (US); Adriane Lewis, Columbus, OH (US); Kelsey Turner, Westerville, OH (US)

(73) Assignee: Materials Engineering and Technical Support Services, Westerville, OH (US)

(21) Appl. No.: 19/110,089

(22) PCT Filed: Sep. 13, 2023
(86) PCT No.: PCT/US2023/074042

§ 371 Date: Mar. 9, 2025

Related U.S. Application Data
(60) Provisional application No. 63/375,521, filed on Sep. 13, 2022.

(51) Int. Cl. C09K 8/536; C09K 8/54

(52) U.S. Cl. CPC C09K 8/536; C09K 8/54; C09K 2208/12; C09K 2208/20; C09K 2208/32

(57) ABSTRACT

Sustained-release scale inhibitors are provided, the sustained-release scale inhibitors comprising: a scale inhibitor; and a polymer, wherein the polymer may be biodegradable; and, optionally, an additive selected from the group consisting of an anti-hydrolysis additive, an antioxidant, a corrosion inhibitor, a biocide, a hydrogen sulfide scavenger, a demulsifier, a clay stabilizer, and mixtures thereof, wherein the scale inhibitor and the additive, when present, are at least partially co-encapsulated by the polymer. Methods for making and using the sustained-release scale inhibitors are also provided.

### CROSS-REFERENCE TO RELATED APPLICATIONS

This application claims priority from U.S. Provisional Patent Application No. 63/375,521, filed on Sep. 13, 2022, which is incorporated by reference herein in its entirety.

### BACKGROUND

Scale formation is a significant problem in oil production wells. Treatment compositions and methods exist, including in the form of so called sustained- or extended-release compositions. However, more effective, longer lasting compositions are needed.

### SUMMARY

In one aspect, a sustained-release scale inhibitor is provided, the sustained-release scale inhibitor comprising: a scale inhibitor; and a polymer, wherein the polymer may be biodegradable; and, optionally, an additive selected from the group consisting of an anti-hydrolysis additive, an antioxidant, a corrosion inhibitor, a biocide, a hydrogen sulfide scavenger, a demulsifier, a clay stabilizer, and mixtures thereof, wherein the scale inhibitor and the additive, when present, are at least partially co-encapsulated by the polymer.

In one aspect, a method is provided, the method comprising treating a subterranean formation or a wellbore by introducing into the subterranean formation or the wellbore a sustained-release scale inhibitor, the sustained-release scale inhibitor comprising: a scale inhibitor; and a polymer, wherein the polymer may be biodegradable; and, optionally, an additive selected from the group consisting of an anti-hydrolysis additive, an antioxidant, a corrosion inhibitor, a biocide, a hydrogen sulfide scavenger, a demulsifier, a clay stabilizer, and mixtures thereof, wherein the scale inhibitor and the additive, when present, are at least partially co-encapsulated by the polymer.

### BRIEF DESCRIPTION OF THE FIGURES

The claimed invention may be more readily understood by reference to the following figures, wherein:

FIG. 1 is a graph of the results of a pore volume test showing phosphorus concentration over effluent volume for an example sustained-release scale inhibitor as described and claimed herein.

FIG. 2 is a graph of the results of a pore volume test and shows phosphorus concentration over effluent volume for an example sustained-release scale inhibitor as described and claimed herein (as depicted in FIG. 1) compared to a product having a conventional formulation.

### DETAILED DESCRIPTION

Sustained-release scale inhibitors are provided that prevent or inhibit the precipitation and/or formation of insoluble salt crystals and crystalline plaques that may hinder the flow of fluids through pipelines, valves, pumps, or other equipment or down-hole regions (e.g., in well or fracking formations) during oil production or processing.

The scale inhibitors may be added directly, may be adsorbed on inorganic media, or may be encapsulated in polymers to extend the in-use working life of the scale inhibitors over a period of months to years. Adsorbed products desorb from the surface or the pores of the inorganic media over time. The polymer encapsulants release scale inhibitors via diffusion or degradation of the polymer matrix. Water-soluble scale inhibitors are released as the polymer absorbs water, thereby dissolving and releasing the encapsulated scale inhibitors. Other scale inhibitors remain phase separated from the polymer and slowly diffuse out of the polymer over time. If the polymer is biodegradable, the environment eventually destroys the polymer, releasing all of the scale inhibitor and leaving no evidence of product use.

In one aspect, the sustained-release scale inhibitors are characterized in that the sustained-release scale inhibitors continue to release phosphorus in a downhole environment at a concentration above 2 parts per million for at least six months, at least 12 months, at least 18 months, at least 24 months, at least 36 months, at least 48 months, or at least 60 months.

### Definitions

The term “about” in conjunction with a number is intended to include ±10% of the number. This is true whether “about” is modifying a stand-alone number or modifying a number at either or both ends of a range of numbers. In other words, “about 10” means from 9 to 11. Likewise, “about 10 to about 20” contemplates 9 to 22 and 11 to 18. In the absence of the term “about” or a clear indication of a range (e.g., +10%) the exact number is intended. In other words, “10” means 10.

The singular forms “a,” “an,” and “the” include plural referents unless the context clearly dictates otherwise. Thus, for example, reference to “a scale inhibitor” also includes a plurality of species of scale inhibitors.

Where a range of values is provided, each intervening value, to the tenth of the unit of the lower limit unless the context clearly dictates otherwise, between the upper and lower limit of that range, and any other stated or intervening value in that stated range, is encompassed. The upper and lower limits of these smaller ranges may independently be included in the smaller ranges and are also encompassed, subject to any specifically excluded limit in the stated range. Where the stated range includes one or both of the limits, ranges excluding either or both of those included limits are also included.

When used in a list, the term “or” is intended to be interpreted as inclusive, unless explicitly stated otherwise, e.g., as in “A or B, but not both.”

Unless defined otherwise, all technical and scientific terms have the same meaning as commonly understood by one of ordinary skill in the art to which this invention belongs.

### Scale Inhibitors

In one aspect, the scale inhibitors may comprise, consist essentially of, or consist of phosphate-, phosphonate-, carboxylate-, or sulfonate-based compounds. In one aspect, the scale inhibitors may also be polymeric in nature and may comprise, consist essentially of, or consist of maleic-, acrylic-, or sulfonic acid-based compounds. In one aspect, the scale inhibitors may comprise, consist essentially of, or consist of aminotris(methylenephosphonic acid) (ATMP) (CAS No. 6419-19-8); ethylenediamine tetra(methylenephosphonic acid) (EDTMP) (CAS No. 1429-50-1); 1-hydroxyethylidene-1,1-diphosphonic acid (HEDP) (CAS No. 2809-21-4); bis-hexamethylene triamine phosphonate (BHMT) (CAS No. 34690-00-1); diethylenetriamine penta(methylene phosphonic acid) (DTPMP) (CAS No. 15827-60-8); polyacrylamide (PAA or PAM) (CAS No. 9003 May 8); poly(2-acrylamido-2-methyl-1-propanesulfonic acid) (polyAMPS); carbonic dihydrazide (H₂N—NH—CO—NH—NH₂); polyaminealkylphosphonic acid and carboxymethyl cellulose or polyacrylamide; polyacrylic acid and chromium; polyacrylates; amine methylene phosphonate; phosphonomethylated polyamine; sulfonated polyacrylate copolymer; bis[tetrakishydroxymethylphosphonium] sulfate; carboxymethyl inulin; polycarboxylic acid salts; phosphoric acid esters of rice bran extract; polyphosphino maleic anhydride; N,N-diallyl-N-alkyl-N-sulfoalkyl ammonium betaine copolymer (with N-vinylpyrollidone or acrylamide (Aam)) diallylmethyltaurine hydrochloride (CH₂═CH—CH₂ClₓCH₃—NH—CH₂—CH₂—SO₃⁻Na⁺); polyaspartates; polyacrolein; naphthylamine polycarboxylic acids; phosphonic acid and hydrofluoric acid; tertiary amines; diethylentrilopentrakismethylenephosphonic acid; tetrakis hydroxyorgano phosphonium salts; phosphino-polycarboxylic acid; diethylentriaminepentaacetic acid; ethylene diamine tetraacetic acid; vinylsulfonate copolymer; phosphinated maleic copolymer; or mixtures thereof.

### Polymers

In one aspect, the polymers may comprise, consist essentially of, or consist of non-biodegradable polymers, including polyolefins, cellulosic polymers, vinyl alcohols, polyamides, and thermoplastic polyesters and polyurethanes, or mixtures thereof.

In another aspect, the polymers may be biodegradable. Biodegradable polymers may comprise, consist essentially of, or consist of polylactides such as polylactic acid (PLA); polybutylene succinate (PBS); polyglycolic acid (PGA); poly(lactide-co-glycolic acid) (PLGA); polycaprolactone (PCL); bio-polyesters such as polyesteramides (PEA), aliphatic co-polyesters (e.g., PBSA), and aromatic co-polyesters (e.g., PBAT); polysaccharides, such as starches (from wheat, potatoes, or maize), lignocellulosic products (from wood or straw), and others (e.g., pectins, chitosan/chitin, dextran, alginate, and hyaluronic acid); proteins and lipids from animals (e.g., casein, whey, collagen, gelatin) or plants (zein, soya, gluten); polythermoplastic starch (TPS); polyhydroxyalkanoate (PHA); polyhydroxybutanoate (PHB); poly(hydroxybuytare-co-hydroxyalerate (PHBV); or mixtures thereof.

In one aspect, the polymer is a blend of polymers for the purpose of tuning the release profile of the sustained-release scale inhibitors. The blend may comprise, for example, two or more non-biodegradable polymers, two or more biodegradable polymers, or a non-biodegradable polymer and a biodegradable polymer.

### Optional Additives

In one aspect, an anti-hydrolysis additive may be co-encapsulated to improve the lifespan of the sustained-release scale inhibitors by preventing or reducing the degradation or breakdown of the polymer. Some polymers, especially polymers containing ester groups or that are manufactured by polycondensation, can display a weakness when attacked by water or moisture, particularly at elevated temperatures. This degradation or breakdown of polymers by water and acids is known as hydrolysis. In one aspect, the anti-hydrolysis additive may comprise, consist essentially of, or consist of calcium stearate or bis(2,6-diisopropylphenyl) carbodiimide.

In one aspect, an antioxidant may be co-encapsulated to improve the lifespan of the sustained-release scale inhibitors by preventing or reducing oxidation of the polymer. Organic materials react with molecular oxygen in a process called “autoxidation.” Autoxidation is initiated by heat, light (high energy radiation), mechanical stress, catalyst residues, or reaction with impurities to form alkyl radicals. The free radical can, in turn, react and result in the degradation of the polymer. Antioxidants protect polymers against oxidation by controlling molecular weight changes that lead to a loss of physical and mechanical properties. In one aspect, the antioxidant may comprise sterically hindered phenols, aromatic amines, phosphites, and thioethers.

In one aspect, a corrosion inhibitor may be co-encapsulated. The corrosion inhibitor may comprise, for example, a cathodic inhibitor; an anodic inhibitor; an inorganic inhibitor; an organic inhibitor; a filming inhibitor; a non-filming inhibitor; an amide or imidazoline; a salt of a nitrogenous molecule with carboxylic acids, e.g., fatty acids and napthenic acids; nitrogenous quaternaries; polyoxylated amines, amides, and imidazolines; nitrogen heterocycles; tetraethylene-pentamine; ethylene diamine; 1,2-propylenediamine; trimethylene diamine; 1,4-butanediamine; acetylenic alcohol; tall oil fatty acids comprising resinic acids, fatty acids, and unsaponifiable material; tall oil fatty acid anhydrides; 3-phenyl-2-propyn-1-ol; dicyclopentadiene dicarboxylic acid salts; hydroxamic acid; cyclohexylammonium benzoate; acyl derivatives of tris-hydroxy-ethyl-perhydro-1,3,5-triazine; 2,4-diamino-6-mercapto pyrimidine sulfate combined with oxysalts of vanadium, niobium, tantalum or titanium, zirconium, or hafnium; aqueous alkanol amine solution; quaternized fatty esters of alkoxylated alkyl-alkylene derivatives; mercaptoalcohols; polysulfide; polyphophonohydroxybenzene sulfonic acid compounds; 1-hydroxyethylidene-1,1-diphosphonic acid; 2-hydroxyphosphono-acetic acid; water-soluble 1,2-dithiol-3-thiones; sulfonated alkyl phenol; polythioether; thiazolidenes; substituted thiacrown ethers pendent on vinyl polymers; benzylsulfinylacetic acid or benzylsulfonylacetic acid; halohydroxyalkylthio-substituted and dihdroxyalkylthio-substituted polycarboxylic acids; alkyl-substituted thiourea; 2,5-bis(N-pyridyl)-1,3,4-oxadiazoles; cinnamaldehyde 1,2-thioethanol dithioacetal; cinnamaldehyde 1,2-dimercapto ethane dithioacetal; cinnamaldehyde thioacetic acid dithioacetal; crotonaldehyde 1,2-thioethanol dithioacetal; crotonaldehyde 1,2-dithiolane dithioacetal; cinnamaldehyde; and thioglycolic acid.

In one aspect, a biocide may be co-encapsulated. The biocide may comprise, for example, zinc slurry; formaldehyde; glutaraldehyde; nitrate; monochloroamine; 3-dazaspiro(4,5)decane; o-phthaldehyde; 2-bromo-4-hydroxyacetophenone; methyl tetrahydrophthalic acid; 2,6-dimethyl-m-dioxan-4-ol acetate; bis[tetrakis(hydroxymethyl) phosphonium]sulfate; thiocyanomethylthio-benzothiazole; 1-(2-hydroxymethyl)-2-methyl-5-nitroimidazole (metronidazole); di-(tri-N-butyl)-(1,4-benzodioxan-6,7-dimethyl) diammonium dichloride; dimethyl-tetrahydro-thiadiazine-thione; pentanedial; 4,4-dimethyl-2-oxazolidinone, glycouril; anthraquinones; phenoxyethanol; tetrakis-(hydroxymethyl)-phosphonium salts; o-phenylphenol; p-chloro-m-cresol; n-butyl benzisothiazolinone; 1,2-benzoisothiazolin-3-one; 2-N-octyl-4-isothiazolin-3-one; 2-methyl-4-isothiazolin-3-one; 3-acetoxy-4-methylthiazole-2(3H)-thione; 3-hydroxy-4-methylthiazol-2(3H)-thione; 3-hydroxy-4-phenylthiazole-2(3H)-thione; isothiazolin-3-one; chlorine dioxide, sodium chlorite; N,N-dimethyl-N′-phenyl-N′-fluoro-dichloromethylthiosulfamidesulfamide; 1-(3-chloroallyl)-3,5,7-triaza-1-azoniaadamantane chloride; 2,3-dibromo-1-chloro-4-thiocyanato-2-butene; 3-(3,4-dichlorophenyl)-1,1-dimethylurea; 4,5-dichloro-2-N-octyl-isothiazolin-3-one; 5-chloro-2-methyl-4-isothiazolin-3-one; chlorothalonil; dichloro-octylisothiazolinone; tributyl tetradecyl phosphonium chloride; dibromo-octylisothiazolinone; 1,2-dibromo-2,4-dicyanobutane; 1-N-hexadecyl-1,2,4-triazole bromide; 2,2-dibromo-2-nitroethanol; 2,2-dibromo-3-nitrilopropionamide (DBNPA); 2-bromo-2-bromomethylglutaronitrile; 2-bromo-2-nitro-1,3-propanediol; bromo-2-nitropropane-1,3-diol (Bronopol); iodine; iodoacetone; iodopropynylbutylcarbamate; diiodomethyltolylsulfone; 1,2-dimethyl-5-nitro-1H-imidazole; 1-hydroxy-5-methyl-4-phenylimidazoline-2-thione; N,N′-methylene-bis-morpholine; 4-(2-nitrobutyl)-morpholine; 4,4′-(2-ethyl-2-nitrotrimethylene)dimorpholine; 1,3,5-tris(2-hydroxyethyl)-s-triazine; 2-methylthio-4-tert-butylamino-6-cyclopropylamino-S-triazine; trimethyl-1,3,5-triazine-1,3,5-triethanol; tetramethylol diurea; acetylene tris(hydroxymethyl)nitromethane; sodium pyrithione; zinc pyrithione; 4,4-dimethyloxazolidine; 7-ethyl bicyclooxazolidine; and dimethylol-dimethyl-hydantoin.

In one aspect, a hydrogen sulfide scavenger may be co-encapsulated. The hydrogen sulfide scavenger may comprise, for example, hexahydro-1,3,5-tris(hydroxyethyl)-s-triazine, monoethanoloamine (MEA) triazine, monomethylamine (MMA) triazine, aldehydes, nitrates, and nitrites.

In one aspect, a demsulifier may be co-encapsulated. The demulsifier may comprise, for example, tannin-based blends; diallyl dimethyl ammonium chloride polymer; amphoteric acrylic acid (AA) copolymer; copolymer of polyglycol acrylate; polyl-acryloyl-4-methyl piperazine; vinyl phenol polymers; ethoxylated or epoxidized PAG; polydimethyl diallyl ammonium chloride; alkoxylated fatty oil; oxalkylated polyalkylene polyamines; crosslinked oxalkylated polyalkylene polyamines; phenol-formaldehyde resins; dithiocarbamates; polythioalkyloxides; polyether polyurethane; sulfonated polystyrenes; asphaltenes; and acid-modified polyol.

In one aspect, a clay stabilizer may be co-encapsulated. The clay stabilizer may comprise, for example, polymer latices; partially hydrolyzed polyvinylacetate; polyacrylamide; copolymer of anionic acid and cationic monomers; acrylic acid; methacrylic acid; 2-acrylamido-2-methyl-1-propane sulfonic acid; dimethyl diallyl ammonium chloride; nitrogen; partially hydrolyzed acrylamide-acrylate copolymer, potassium chloride, and polyanionic cellulose; aluminum/guanidine complexes with cationic starches and polyalkylene glycols; hydroxyaldehydes or hydroxyketones; polyols and alkaline salt; tetramethylammonium chloride and methyl chloride quaternary salt of polyethyleneimine; pyruvic aldehyde and a triamine; quaternary ammonium compounds; in situ crosslinking of epoxide resins; oligomer (methyl quaternary amine containing 3-6 moles of epihalohydrin); quaternary ammonium carboxylates; quaternized trihydroxyalkyl amine; polyvinyl alcohol, potassium silicate, and potassium carbonate; copolymer of styrene and substituted maleic anhydride; potassium salt of carboxymethyl cellulose; and water-soluble polymers with sulfosuccinate derivative-based surfactants and zwitterionic surfactants.

### EXAMPLES

The foregoing detailed description and the following examples have been given for clarity of understanding only. No unnecessary limitations are to be understood therefrom. The invention is not limited to the exact details shown and described, as variations obvious to one skilled in the art will be included within the invention defined by the claims.

### Example 1: Sustained-Release Scale Inhibitor

### 1.1 Pilot Formulation.

| Component | Purpose | Loading (%/wt) |
|---|---|---|
| Ingeo Biopolymer 4043D | Biodegradable Polymer | 80 |
| (NatureWorks) | (encapsulant) | |
| ATMP | Scale Inhibitor | 19 |
| Calcium Stearate | Anti-Hydrolysis Agent | 1 |

### 1.2 Preparation of Pilot Formulation.

ATMP and calcium stearate were dry-blended at targeted weight percentages. The blended materials were melt-processed using a single screw extruder. The melt temperature was about 170° C., and the screw speed was 30 rpm. The extruder was vented to allow excess moisture to be extracted from the melt. The product was extruded into strands, cooled in a water bath, dried with an air-knife, and cut to length.

### Example 2: Pore Volume Testing of Pilot Formulation

The concentration of ATMP in a downhole solution must remain at or above 2-3 ppm (measured as phosphorus content) for the scale inhibitor to be efficacious (minimum inhibitor concentration, MIC). Zeino, A., Albakri, M., Khaled, M., & Zarzour, M. (2018). Comparative study of the synergistic effect of ATMP and DTPMPA on Caso 4 scale inhibition and evaluation of induction time effect. Journal of Water Process Engineering, 21, 1-8. https://doi.org/10.1016/j.jwpe.2017.11.013, the entire disclosure of which is incorporated by reference herein.

To evaluate performance in a simulated downhole environment, the pilot formulation was subjected to pore volume testing. See, e.g., U.S. Patent Application Publication No. US2006/0124302A1, paras. [0048]-[0049] of which are incorporated by reference herein. The pilot formulation was added at 2%/wt to 40/60 mesh sand and packed (dry) into a 500 mL column. Using a diaphragm pump, deionized water was pumped through the column at a rate of 20 mL/min. 100 mL samples of the effluent were collected periodically and analyzed for acid concentration via titration using 0.1M NaOH as the titrant. The phosphorus content of the solution was calculated from the concentration measured in the effluent and the phosphorus content in ATMP. The test duration was approximately 26 hours.

For the applicant's specific test setup, one pore volume is equal to 180 mL. Approximately 19 pore volumes equate to one month of downhole activity. In the measured test duration, the pilot formation released above 2 ppm phosphorus over the duration of the test, i.e., over 170 pore volumes. The results are shown in Error! Reference source not found. This result extrapolates to a sustained release of above 2 ppm phosphorus for about 175 months.

### Comparative Example: Pore Volume Testing of FlowSure™ SI 503

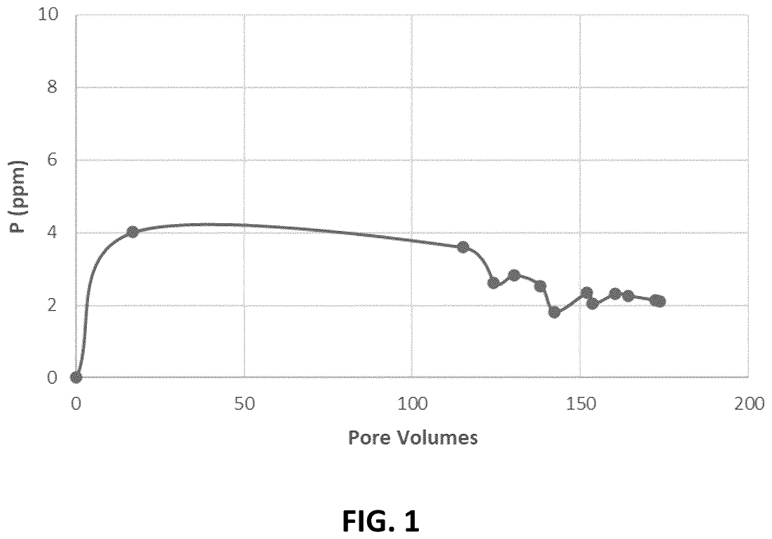

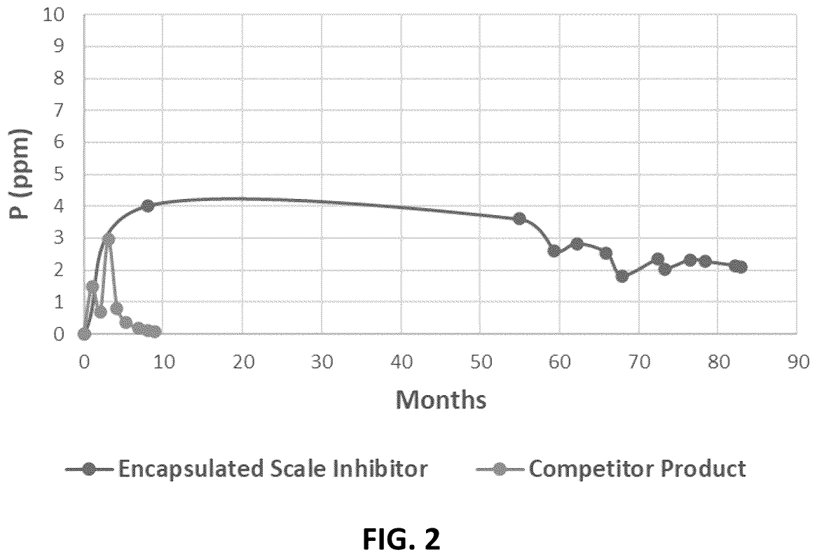

A product having a conventional formulation, FlowSure™ SI 503, was subjected to the same pore volume test set up as described in Example 2. Activity was only able to be measured for ˜3 hours before the concentration of phosphorus was below the limit of detection. Based on the determined correlation between effluent volume and time, the FlowSure™ SI 503 product is estimated to last 8.5 months. FIG. 2 shows a graph of phosphorus concentration over effluent volume for the pilot formulation (as depicted in FIG. 1) compared to the FlowSure™ SI 503_product.

The pilot formulation as claimed herein lasted substantially longer under identical test conditions than the FlowSure™ SI 503 product, indicating superior performance as a sustained-release scale inhibitor.

1. A sustained-release scale inhibitor, comprising:
(A) a scale inhibitor; and
(B) a polymer; and, optionally,
(C) an additive selected from the group consisting of an anti-hydrolysis additive, an antioxidant, a corrosion inhibitor, a biocide, a hydrogen sulfide scavenger, a demulsifier, a clay stabilizer, and mixtures thereof,
wherein the scale inhibitor and, when present, the additive, are at least partially co-encapsulated by the polymer.

2. The sustained-release scale inhibitor of claim 1, wherein the scale inhibitor comprises at least one of a phosphate-, phosphonate-, carboxylate-, or sulfonate-based compound.

3. The sustained-release scale inhibitor of claim 1, wherein the scale inhibitor comprises at least one of a poly-maleic, poly-acrylic, or poly-sulfonic acid-based compound.

4. The sustained-release scale inhibitor of claim 1, wherein the scale inhibitor is selected from the group consisting of aminotris(methylenephosphonic acid) (ATMP); 1-hydroxyethylidene-1,1-diphosphonic acid (HEDP); bis-hexamethylene triamine phosphonate (BHMT); ethylenediamine tetra(methylenephosphonic acid) (EDTMP); diethylenetriamine penta(methylene phosphonic acid) (DTPMP); polyacrylamide (PAA or PAM); poly(2-acrylamido-2-methyl-1-propanesulfonic acid) (polyAMPS); carbonic dihydrazide (H₂N—NH—CO—NH—NH₂); polyaminealkylphosphonic acid and carboxymethyl cellulose or polyacrylamide; polyacrylic acid and chromium; polyacrylates; amine methylene phosphonate; phosphonomethylated polyamine; sulfonated polyacrylate copolymer; bis[tetrakishydroxymethylphosphonium]sulfate; carboxymethyl inulin; polycarboxylic acid salts; phosphoric acid esters of rice bran extract; polyphosphino maleic anhydride; N,N-diallyl-N-alkyl-N-sulfoalkyl ammonium betaine copolymer with N-vinylpyrollidone or acrylamide (Aam) diallylmethyltaurine hydrochloride (CH₂—CH—CH₂ClₓCH₃—NH—CH₂—CH₂—SO₃⁻Na⁺); polyaspartates; polyacrolein; naphthylamine polycarboxylic acids; phosphonic acid and hydrofluoric acid; tertiary amines; diethylentrilopentrakismethylenephosphonic acid; tetrakis hydroxyorgano phosphonium salts; phosphino-polycarboxylic acid; diethylentriaminepentaacetic acid; ethylene diamine tetraacetic acid; vinylsulfonate copolymer; phosphinated maleic copolymer; or mixtures thereof.

5. The sustained-release scale inhibitor of claim 1, wherein the scale inhibitor comprises ATMP.

6. The sustained-release scale inhibitor of claim 1, wherein the scale inhibitor comprises BHMT.

7. The sustained-release scale inhibitor of claim 1, wherein the polymer comprises a non-biodegradable polymer selected from the group consisting of polyolefins, cellulosic polymers, vinyl alcohols, polyamides, thermoplastic polyesters and polyurethanes, or mixtures thereof.

8. The sustained-release scale inhibitor of claim 1, wherein the polymer is biodegradable.

9. The sustained-release scale inhibitor of claim 8, wherein the biodegradable polymer comprises at least one of polylactic acid (PLA); polybutylene succinate (PBS); polyglycolic acid (PGA); poly(lactide-co-glycolic acid) (PLGA); polycaprolactone (PCL); thermoplastic starch (TPS); polyhydroxyalkanoate (PHA); bio-polyesters; polyesteramides (PEA); aliphatic co-polyesters; aromatic co-polyesters; polysaccharides; starches; lignocellulosic products; pectins; chitosan/chitin; dextran; alginate; hyaluronic acid; proteins; lipids; casein; whey; collagen; gelatin; zein; soya; gluten; polythermoplastic starch (TPS); polyhydroxyalkanoate (PHA); polyhydroxybutanoate (PHB); poly(hydroxybuytare-co-hydroxyalerate (PHBV); or mixtures thereof.

10. The sustained-release scale inhibitor of claim 9, wherein the biodegradable polymer comprises a PLA.

11. The sustained-release scale inhibitor of claim 1, wherein the additive is present and comprises an anti-hydrolysis additive.

12. The sustained-release scale inhibitor of claim 11, wherein the anti-hydrolysis additive comprises at least one of calcium stearate and bis(2,6-diisopropylphenyl) carbodiimide.

13. The sustained-release scale inhibitor of claim 11, wherein the anti-hydrolysis additive comprises calcium stearate.

14. The sustained-release scale inhibitor of claim 1, wherein the additive is present and comprises an antioxidant.

15. The sustained-release scale inhibitor of claim 14, wherein the antioxidant is selected from the group consisting of sterically hindered phenols, aromatic amines, phosphites, and thioethers.

16. The sustained-release scale inhibitor of claim 1, wherein the additive is present and comprises a corrosion inhibitor.

17. The sustained-release scale inhibitor of claim 16, wherein the corrosion inhibitor is selected from the group consisting of a cathodic inhibitor; an anodic inhibitor; an inorganic inhibitor; an organic inhibitor; a filming inhibitor; a non-filming inhibitor; an amide or imidazoline; a salt of a nitrogenous molecule with carboxylic acids; nitrogenous quaternaries; polyoxylated amines, amides, and imidazolines; nitrogen heterocycles; tetraethylene-pentamine; ethylene diamine; 1,2-propylenediamine; trimethylene diamine; 1,4-butanediamine; acetylenic alcohol; tall oil fatty acids comprising resinic acids, fatty acids, and unsaponifiable material; tall oil fatty acid anhydrides; 3-phenyl-2-propyn-1-ol; dicyclopentadiene dicarboxylic acid salts; hydroxamic acid; cyclohexylammonium benzoate; acyl derivatives of tris-hydroxy-ethyl-perhydro-1,3,5-triazine; 2,4-diamino-6-mercapto pyrimidine sulfate combined with oxysalts of vanadium, niobium, tantalum, titanium, zirconium, or hafnium; aqueous alkanol amine solution; quaternized fatty esters of alkoxylated alkyl-alkylene derivatives; mercaptoalcohols; polysulfide; polyphophonohydroxybenzene sulfonic acid compounds; 1-hydroxyethylidene-1,1-diphosphonic acid; 2-hydroxyphosphono-acetic acid; water-soluble 1,2-dithiol-3-thiones; sulfonated alkyl phenol; polythioether; thiazolidines; substituted thiacrown ethers pendent on vinyl polymers; benzylsulfinylacetic acid or benzylsulfonylacetic acid; halohydroxyalkylthio-substituted and dihdroxyalkylthio-substituted polycarboxylic acids; alkyl-substituted thiourea; 2,5-bis(N-pyridyl)-1,3,4-oxadiazoles; cinnamaldehyde 1,2-thioethanol dithioacetal; cinnamaldehyde 1,2-dimercapto ethane dithioacetal; cinnamaldehyde thioacetic acid dithioacetal; crotonaldehyde 1,2-thioethanol dithioacetal; crotonaldehyde 1,2-dithiolane dithioacetal; cinnamaldehyde; thioglycolic acid; or mixtures thereof.

18. The sustained-release scale inhibitor of claim 1, wherein the additive is present and comprises a biocide.

19. The sustained-release scale inhibitor of claim 18, wherein the biocide is selected from the group consisting of zinc slurry; formaldehyde; glutaraldehyde; nitrate; monochloroamine; 3-dazaspiro(4,5)decane; o-phthaldehyde; 2-bromo-4-hydroxyacetophenone; methyl tetrahydrophthalic acid; 2,6-dimethyl-m-dioxan-4-ol acetate; bis[tetrakis(hydroxymethyl)phosphonium]sulfate; thiocyanomethylthio-benzothiazole; 1-(2-hydroxymethyl)-2-methyl-5-nitroimidazole=(metronidazole); di-(tri-N-butyl)-(1,4-benzodioxan-6,7-dimethyl)diammonium dichloride; dimethyl-tetrahydro-thiadiazine-thione; pentanedial; 4,4-dimethyl-2-oxazolidinone, glycouril; anthraquinones; phenoxyethanol; tetrakis-(hydroxymethyl)-phosphonium salts; o-phenylphenol; p-chloro-m-cresol; n-butyl benzisothiazolinone; 1,2-benzoisothiazolin-3-one; 2-N-octyl-4-isothiazolin-3-one; 2-methyl-4-isothiazolin-3-one; 3-acetoxy-4-methylthiazole-2(3H)-thione; 3-hydroxy-4-methylthiazol-2(3H)-thione; 3-hydroxy-4-phenylthiazole-2(3H)-thione; isothiazolin-3-one; chlorine dioxide, sodium chlorite; N,N-dimethyl-N′-phenyl-N′-fluoro-dichloromethylthiosulfamidesulfamide; 1-(3-chloroallyl)-3,5,7-triaza-1-azoniaadamantane chloride; 2,3-dibromo-1-chloro-4-thiocyanato-2-butene; 3-(3,4-dichlorophenyl)-1,1-dimethylurea; 4,5-dichloro-2-N-octyl-isothiazolin-3-one; 5-chloro-2-methyl-4-isothiazolin-3-one; chlorothalonil; dichloro-octylisothiazolinone; tributyl tetradecyl phosphonium chloride; dibromo-octylisothiazolinone; 1,2-dibromo-2,4-dicyanobutane; 1-N-hexadecyl-1,2,4-triazole bromide; 2,2-dibromo-2-nitroethanol; 2,2-dibromo-3-nitrilopropionamide (DBNPA); 2-bromo-2-bromomethylglutaronitrile; 2-bromo-2-nitro-1,3-propanediol; bromo-2-nitropropane-1,3-diol (Bronopol); iodine; iodoacetone; iodopropynylbutylcarbamate; diiodomethyltolylsulfone; 1,2-dimethyl-5-nitro-1H-imidazole; 1-hydroxy-5-methyl-4-phenylimidazoline-2-thione; N,N′-methylene-bis-morpholine; 4-(2-nitrobutyl)-morpholine; 4,4′-(2-ethyl-2-nitrotrimethylene)dimorpholine; 1,3,5-tris(2-hydroxyethyl)-s-triazine; 2-methylthio-4-tert-butylamino-6-cyclopropylamino-S-triazine; trimethyl-1,3,5-triazine-1,3,5-triethanol; tetramethylol acetylene diurea; tris(hydroxymethyl)nitromethane; sodium pyrithione; zinc pyrithione; 4,4-dimethyloxazolidine; 7-ethyl bicyclooxazolidine; dimethylol-dimethyl-hydantoin; or mixtures thereof.

20. The sustained-release scale inhibitor of claim 1, wherein the additive is present and comprises a hydrogen sulfide scavenger.

21. The sustained-release scale inhibitor of claim 20, wherein the hydrogen sulfide scavenger comprises hexahydro-1,3,5-tris(hydroxyethyl)-s-triazine, monoethanoloamine (MEA) triazine, monomethylamine (MMA) triazine, aldehydes, nitrates, and nitrites.

22. The sustained-release scale inhibitor of claim 1, wherein the additive is present and comprises a demulsifier.

23. The sustained-release scale inhibitor of claim 22, wherein the demulsifier is selected from the group consisting of tannin-based blends; diallyl dimethyl ammonium chloride polymer; amphoteric acrylic acid (AA) copolymer; copolymer of polyglycol acrylate; poly-acryloyl-4-methyl piperazine; vinyl phenol polymers; ethoxylated or epoxidized PAG; polydimethyl diallyl ammonium chloride; alkoxylated fatty oil; oxalkylated polyalkylene polyamines; crosslinked oxalkylated polyalkylene polyamines; phenol-formaldehyde resins; dithiocarbamates; polythioalkyloxides; polyether polyurethane; sulfonated polystyrenes; asphaltenes; acid-modified polyol; or mixtures thereof.

24. The sustained-release scale inhibitor of claim 1, wherein the additive is present and comprises a clay stabilizer.

25. The sustained-release scale inhibitor of claim 24, wherein the clay stabilizer is selected from the group consisting of polymer latices; partially hydrolyzed polyvinylacetate; polyacrylamide; copolymer of anionic acid and cationic monomers; acrylic acid; methacrylic acid; 2-acrylamido-2-methyl-1-propane sulfonic acid; dimethyl diallyl ammonium chloride; nitrogen; partially hydrolyzed acrylamide-acrylate copolymer, potassium chloride, and polyanionic cellulose; aluminum/guanidine complexes with cationic starches and polyalkylene glycols; hydroxyaldehydes or hydroxyketones; polyols and alkaline salt; tetramethylammonium chloride and methyl chloride quaternary salt of polyethyleneimine; pyruvic aldehyde and a triamine; quaternary ammonium compounds; in situ crosslinking of epoxide resins; oligomer (methyl quaternary amine containing 3-6 moles of epihalohydrin); quaternary ammonium carboxylates; quaternized trihydroxyalkyl amine; polyvinyl alcohol, potassium silicate, and potassium carbonate; copolymer of styrene and substituted maleic anhydride; potassium salt of carboxymethyl cellulose; and water-soluble polymers with sulfosuccinate derivative-based surfactants and zwitterionic surfactants.

26. The sustained-release scale inhibitor of claim 1, wherein the polymer is a blend of polymers having different release profiles.

27. The sustained-release scale inhibitor of claim 1, wherein the sustained-release scale inhibitor is characterized in that the sustained-release scale inhibitor continues to release phosphorus in a downhole environment at a concentration above 2 parts per million for at least twelve months.

28. A sustained-release scale inhibitor comprising:
(A) a scale inhibitor comprising trimethylenephosphonic acid (ATMP) and/or bis-hexamethylene triamine phosphonate (BHMT);
(B) a polylactic acid (PLA) polymer; and
(C) an anti-hydrolysis additive comprising calcium stearate and/or bis(2,6-diisopropylphenyl) carbodiimide,
wherein the scale inhibitor and the anti-hydrolysis additive are at least partially co-encapsulated by the PLA polymer.

29. The sustained-release scale inhibitor of claim 28, further comprising an additional additive selected from the group consisting of an antioxidant, a corrosion inhibitor, a biocide, a hydrogen sulfide scavenger, a demulsifier, a clay stabilizer, and mixtures thereof, wherein the scale inhibitor, the anti-hydrolysis additive, and the additional additive are at least partially co-encapsulated by the PLA polymer.

30. A method for treating a subterranean formation or a wellbore, the method comprising: providing a sustained-release scale inhibitor, the sustained-release scale inhibitor comprising a sustained-release scale inhibitor as claimed in claim 28.

31. The method of claim 30, wherein the introduction is required less frequently than every twelve months in order for the sustained-release scale inhibitor to continuously release phosphorus in a downhole environment at a concentration above 2 parts per million.

32. A method for treating a subterranean formation or a wellbore, the method comprising: providing a sustained-release scale inhibitor, the sustained-release scale inhibitor comprising a sustained-release scale inhibitor as claimed in claim 28.
